(19) United States
(12) Patent Application Publication
(10) Pub. No.: US 2007/0233750 A1
(43) Pub. Date: Oct. 4, 2007

(54) Data control apparatus and method

(75) Inventors: Jhih-siang Jhang, Taipei City (TW); Wei-guan Yau, Hsin-Chu City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: MediaTek Inc.

(21) Appl. No.: 11/392,977

(22) Filed: Mar. 28, 2006

(51) Int. Cl. G06F 17/30

(52) U.S. Cl. 707/201

(57) ABSTRACT

This present invention introduces a data control apparatus and method for global navigation satellite system (GNSS). The data control apparatus has a serial transport interface for transporting data blocks at a data transfer rate from a data source. A microprocessor executes a program routine for sequentially writing the data blocks into the main memory unit at a data accessing rate. While the bit sizes of the data blocks have been pre-compressed, the decompressor will decompress the data blocks to reduce the transfer time of the data blocks through the serial interface thereby eliminating a speed bottle of the data transfer rate if the data transfer rate is slower than the data accessing rate of the main memory unit.

### BACKGROUND OF INVENTION

1. Field of the Invention

This present invention relates to a data control apparatus and a method for global navigation satellite system (GNSS), which is capable of expediting an efficient firmware update.

2. Description of the Prior Art

Typically, a Global Navigation satellite system (GNSS) represents a Global Positioning System (GPS), a Global Orbiting Navigation Satellite System (GLONASS), a future European Galileo system, or various other systems to determine geodetic coordinates of a carrier employing said system. As well known in the art, the GPS devices are more widely used and will be as an example of a GNSS introduced hereinafter.

Most electric devices such as the global navigation satellite systems (GNSS) have specific firmware codes embedded within the hardware architecture. The electronic device runs specialized functions by way of executing the firmware codes under the hardware operation. The latest firmware codes are sustained by an update procedure and often transmitted from an external data source to the electric device.

A conventional electrical device manipulates a central processing unit to download the updated firmware codes from a debugging tool into an internal flash memory via a JTAG (Joint Test Action Group) serial interface. The JTAG interface that adopts at least five pins more than other kinds of serial interfaces would cause a higher area cost with regard to its associated circuitry.

Another conventional electrical device also manipulates a microprocessor to download an updated firmware routine from an external computer into a flash memory (i.e. an external ROM) through an Integrated Drive Electronics (IDE) or a Small Computer System Interface (SCSI) bus. Similarly, either the generic IDE interface using approximate 40-44 pins or the SCSI interface using approximate 50-68 pins still costs higher due to a larger area occupied by its associated circuitry.

### SUMMARY OF INVENTION

To resolve the aforementioned problems, it is therefore a primary objective of the present invention to provide a data control apparatus and a method for a global navigation satellite system (GNSS), with capabilities of saving more costs and performing a highly efficient firmware update.

To achieve the aforementioned objectives, the data control apparatus according to the present invention has a microprocessor, a serial transport interface, a decompressor, a booting memory unit, a buffer memory unit and a main memory unit. The serial transport interface transports a number of specific data at a data transfer rate between the global navigation satellite system and a data source. The specific data contains some data blocks of updated firmware codes and a program routine. The microprocessor is operative to execute the program routine for sequentially writing the data blocks of the specific data into the main memory unit. The main memory unit such as a flash memory accesses the data blocks therein at a data accessing rate faster than the data transfer rate of the serial transport interface. The buffer memory unit may pre-store the specific data therein via the microprocessor. The decompressor is operative to decompress the bit size of the data blocks if the data blocks have been pre-compressed wherein the decompressor may be located between the microprocessor and the main memory unit to decompress the data blocks before the data blocks are written into the main memory unit, or between the microprocessor and the buffer memory unit to decompress the data blocks before the data blocks are fetched by the microprocessor from the buffer memory unit.

Furthermore, the present invention provides a method for controlling a firmware update of a global navigation satellite system via the data control apparatus having a microprocessor, a serial transport interface and a main memory unit. The method comprises the following steps:

fetching a program routine from a data source through the transport interface employing a data transfer rate;

executing the program routine;

sequentially transferring a number of data blocks of updated firmware codes compressed in bit sizes from the data source via the serial transport interface;

decompressing the data blocks before or after storing the data blocks within a buffer memory unit, or decompressing the data blocks before the data blocks are written in the main memory unit if the data blocks have been pre-compressed;
writing each of the data blocks into the main memory unit at a data accessing rate faster than the data transfer rate of the serial transport interface;
programming each of the data blocks into the main memory unit; and
verifying whether each of the data blocks is successfully written into the main memory unit until all of the data blocks of the updated firmware codes are downloaded into the main memory unit completely.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1A illustrates a schematic architecture diagram of a global navigation satellite system with a data control apparatus according to a first preferred embodiment of the present invention;

FIG. 1B illustrates a schematic architecture diagram of a global navigation satellite system with a data control apparatus according to a second preferred embodiment of the present invention;

FIG. 2 illustrates a memory address allocation diagram of a global navigation satellite system receiver, which maps different memory units therein;

FIG. 3 illustrates a flow chart of an operating procedure of a global navigation satellite system according to the present invention; and

FIG. 4 illustrates a flow chart of a data control method for a firmware update of the global navigation satellite system according to the present invention

### DETAILED DESCRIPTION

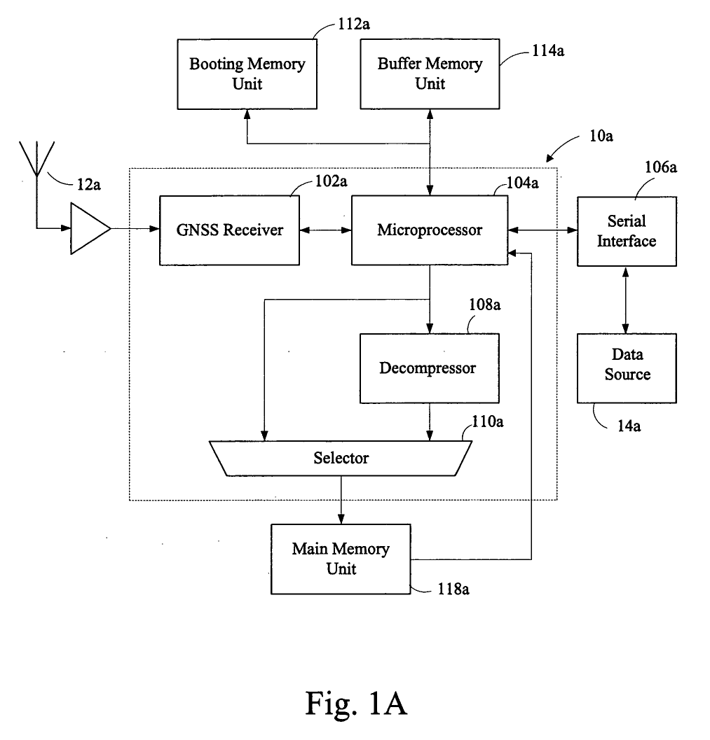

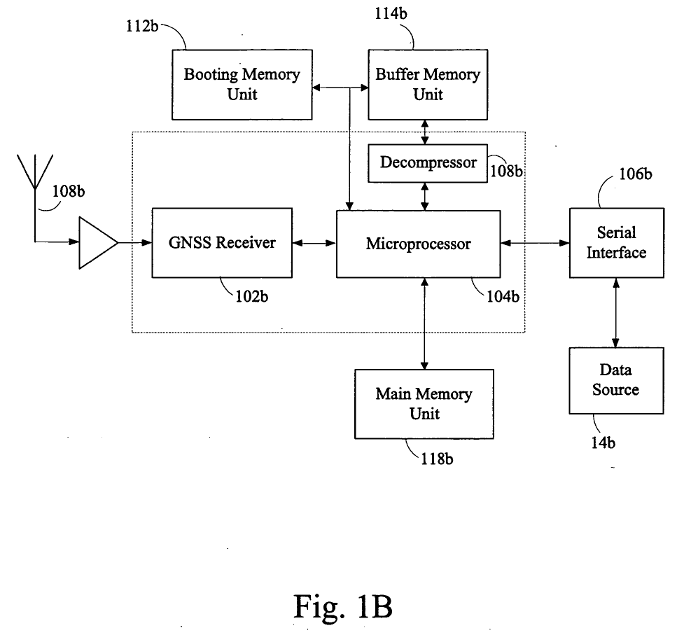

Firstly referring to FIG. 1, a receiver 102a in a global navigation satellite system (GNSS) is operative to receive a broadcast signal from a remote GNSS satellite through an antenna 12a and processes the broadcast signal. Since the GNSS receiver 102a needs to employ number of specific data to operate, the specific data has to be pre-stored prior to the usage. For any person skilled in the same art, the global navigation satellite system receiver 102a mentioned in the present invention is not restricted to a GPS device and may be applicable to other GNSS-type devices according to the spirit and scope of the present invention.

A data control apparatus according to a first preferred embodiment of the present invention is proposed to process the specific data involved in operation of the GNSS receiver 102a. Said specific data is supplied from an external data source 14a (i.e. a personal computer) to the GNSS receiver 102a via the data control apparatus, and primarily contains data blocks of updated firmware codes and an updating-firmware program routine. The bit sizes of data blocks of the updated firmware codes possibly have been pre-compressed prior to the entry of the updated firmware codes into the global navigation satellite system. The updating-firmware program routine as a download agent (DA) program can be executed to directionally download the updated firmware codes from the data source 14a to the data control apparatus. Accordingly, the updated firmware codes are used to substitute the previous one existing in the data control apparatus and then are executed to accomplish operation of the GNSS receiver 102a.

The data control apparatus includes a microprocessor 104a, a serial transport interface 106a, a decompressor 108a, a selector 110a, a booting memory unit 112a, a buffer memory unit 114a and a main memory unit 118a. The serial transport interface 106a, for example, a universal asynchronous receiver transmitter (UART), a universal serial bus (USB) interfaces or the like, has a bandwidth as a data transfer rate to transmit the specific data between the GNSS receiver 102a and the data source 14a. For this embodiment, usage of a UART serial transport interface is optimal due to the need of less pin numbers (i.e. two I/O pins only) thereby leading in an area-cost saving, but does not therefore exclude other serial interfaces with usage of more than two I/O pins.

The booting memory unit 112a like a read-only memory (ROM) pre-stores therein a booting program that contains an interface access mechanism and a memory access control mechanism. For this embodiment, the booting program is firstly loaded from the booting memory unit 112 to the buffer memory unit 114a and then is performed to initialize configuration of the microprocessor 104a for accurately accessing the specific data through which one predefined interface (i.e. a UART interface) and addressing the specific data into which corresponding memory unit. The booting program further contains a firmware update subroutine for switching to a firmware update procedure while the microprocessor 104a is informed of a firmware update request from the data source 14a.

By the firmware update subroutine of the booting program, the microprocessor 104a is configured to individually obtain the updating-firmware program routine and the data blocks of the updated firmware codes contained in the specific data from the data source 14a via the UART serial interface 106a, with respect to the firmware update request from the data source 14a. Furthermore, the microprocessor 104a firstly allocates the program routine alone into the buffer memory unit 114a (e.g. a random access memory (RAM)) and then executes the program routine to directly transfer the compressed data blocks of the updated firmware codes from the UART serial interface 106a to the main memory unit 118a, or transfer the compressed data blocks of the updated firmware codes from the UART serial interface 106a to the main memory unit 118a via the buffer memory unit 114a.

Prior to entry of the updated firmware codes into the main memory unit 118a, the microprocessor 104a would depend upon whether a compression character occurs in the bit size of the updated firmware codes to enable/disable the decompressor 108a to decompress the data block or not. The decompressor 108a that can be accomplished in either hardware or software structure is optional to decompress the data blocks of the updated firmware codes from the microprocessor 104a to recover in original bit size if the updated firmware codes have been pre-compressed before transmitted from the data source 14a. In other case, the decompressor 108a may be integrated within the microprocessor 104a.

The selector 110a as a multiplex is switched by the microprocessor 104a to output either a size-unchanged data block (with non-compressed bit size) or a decompressed data block supplied from the data source 14a to the main memory unit 118a. Then the main memory unit 118a as a flash memory (i.e. an EEPROM), sequentially store therein each data block of executable updated firmware codes at a data accessing rate which is inherently faster than the data transfer rate of the UART serial transport interface 106a. Thereafter the updating-firmware program routine pre-stored in the buffer memory unit 114a is executed by the microprocessor 104a to program a memory address of data space in the main memory unit 118a with the updated firmware codes pre-stored in the main memory unit 118a. In other case, the updated firmware codes may be programmed by the microprocessor 104a into the main memory unit 118a via the buffer memory unit 114a.

Noted is that if the main memory unit 118a as a flash memory cannot support a page mode function to perform a flash download, a programming time of the specific data to the main memory unit 118a is about 10 us typically. In the other word, the bandwidth of the UART serial interface 106a to transfer the data may be 100 k bytes enough. Generally speaking, the total data amount of the data blocks and program routine used by GNSS receiver 102a for the update operation is less than IM bytes. If the data accessing rate of the main memory unit 118a is above 100 k bytes/sec, the accessing time of the specific data from/into the main memory unit 118a would be less than 10 seconds. In comparison with the data storing rate of the main memory unit 118a for the flash download, the bandwidth (i.e., the data transfer rate) of the UART serial interface 106a is approximate 115.2 k bit/sec, which is slower than the need of the flash download and likely results in a data-underflow problem in the main memory unit 118a. Thus, the invention firstly utilizes data compression to reduce the bit size of the updated firmware codes before the codes are transferred through the UART serial interface 106a. The transfer time of the updated firmware codes through the UART serial interface 106a therefore can be shortened greatly. Furthermore, the updated firmware codes are decompressed before the microprocessor 104a downloads the updated firmware codes into the main memory unit 118a. By the way, the data transportation of the UART serial interface 106a under the limitation of its less bandwidth can become sufficient to perform the flash download.

For various applications, the GNSS receiver 102a, the microprocessor 104a, the decompressor 108a and the selector 110a may be further integrated into a standalone electrical system 10a as a control chip applied for the global navigation satellite system.

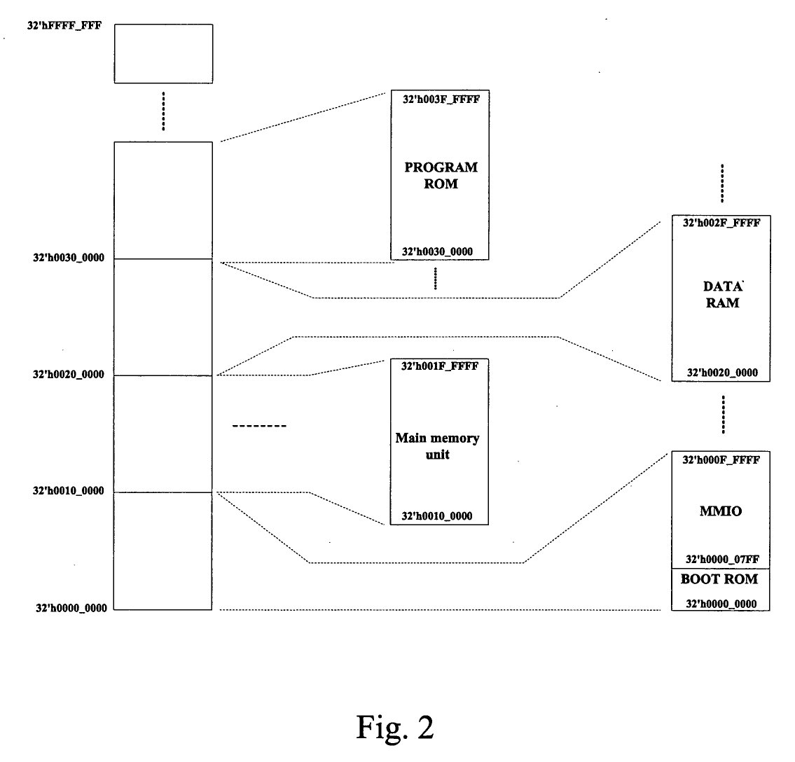

Referring to FIG. 2, a lot of memory address allocation regions for the GNSS receiver 102a respectively map the different memory unit therein as soon as the GNSS receiver 102a operates normally. For examples, an address region (32′h0000_{—}07FF to 32′h0000_{—}0000) is configured for usage of the booting memory unit. Data usage of a MMIO (memory mapped I/O) is allocated within an address region (32′h000F_FFFF to 32′h0000_{—}07FF). Data usage of the main memory unit is allocated within an address region (32′h001F_FFFF to 32′h0010_{—}0000) for storing the program routine or the data blocks of the updated firmware codes. A data RAM is allocated within an address region (32′h002F_FFFF to 32′h0020_{—}0000). A program ROM is allocated within an address region (32′h003F_FFFF to 32′h0030_{—}0000) and used as a storage unit.

Further referring to a second preferred embodiment of the present invention shown in FIG. 1B, a data control apparatus applied for a GNSS receiver 102b includes a microprocessor 104b, a serial transport interface 106b, a decompressor 108b, a booting memory unit 112b, a buffer memory unit 114b and a main memory unit 118b. Also the serial transport interface 106b as a UART employs a data transfer rate to transmit specific data between the GNSS receiver 102b and a data source 14b, and the main memory unit 118b accesses the data block at a data accessing rate faster than the data transfer rate of the serial transport interface 106b. The buffer memory unit 114b coupled to the microprocessor 104b pre-stores the specific data transferred from the serial interface 106b via the microprocessor 104b.

Differently from the first preferred embodiment depicted in FIG. 1A, the data control apparatus of the second embodiment specifies that the decompressor 108b interconnects between the microprocessor 104b and the buffer memory unit 114b, and absence of a selector. There are several following ways to process the data blocks of the compressed updated firmware codes. One way is that the data blocks of the compressed updated firmware codes received from the serial transport interface 106b is directly addressed into the buffer memory unit 114b for pre-storage. Then the microprocessor 104b fetches the data blocks of the compressed updated firmware codes from the buffer memory unit 114b and enables the decompressor 108b to decompress the data blocks of the compressed updated firmware codes into the main memory unit 118b prior to entry of the data blocks into the main memory nit 118b, or the decompressor 108b is configured to firstly decompress the data blocks into the buffer memory unit 114b and then the data blocks of the decompressed updated firmware codes are fetched by the microprocessor 104b from the buffer memory unit 114b to be allocated (or programmed) into the main memory unit 118b.

The other way is that the data blocks of the compressed updated firmware codes from the serial transport interface 106b is addressed into the main memory unit 118b via the microprocessor 104b for pre-storage. Then the data blocks of the compressed updated firmware are loaded from the main memory unit 118b into the buffer memory unit 114b for data processing of the microprocessor 104b. The decompressor 108b can be configured to decompress the data blocks into the main memory unit 118b (i.e. for data programming) after the data blocks are fetched by the microprocessor 104b from the buffer memory unit 114b, or firstly decompress the data blocks into the buffer memory unit 114b and then the microprocessor 104b fetches the data blocks of decompressed updated firmware from the buffer memory unit 114b thereby respectively allocating (i.e. for data programming) the data blocks of the decompressed updated firmware into the main memory unit 118b via the microprocessor 104b.

In the other embodiment, an updating-firmware program routine as DA received from an UART serial interface may be configured to be firstly stored within a main memory unit. Then a microprocessor can execute the updating-firmware program routine from the main memory unit or move the program routine to the other memory, e.g. a buffer memory unit.

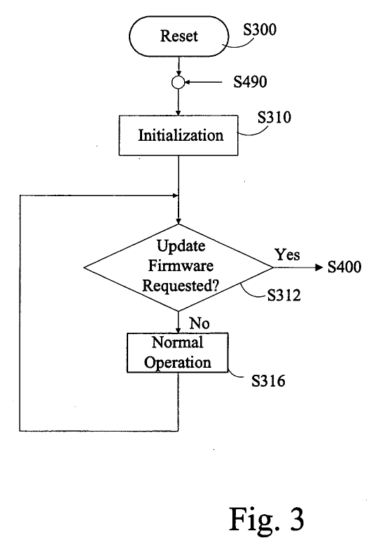

Furthermore, a flow chart of an operating procedure of a global navigation satellite system (GNSS) is depicted in FIG. 3. In step 300, a GNSS receiver is activated by reset. In step S310, a microprocessor coupled to the GNSS receiver finishes the initialization after the microprocessor executes a booting program loaded from a booting memory unit to a buffer memory unit. Then the microprocessor will handshake with a data source (i.e. PC) through a serial transport interface (i.e. a UART). In step S312, the microprocessor determines whether a firmware update is requested from the data source. If so, the microprocessor will further execute a firmware update subroutine contained in the booting program to switch next procedure to a step S400 for updating firmware (detailed thereafter). Otherwise as a step S312, a normal operation is kept executed upon the present firmware to control the GNSS receiver and do signal processing. Similarly, if a firmware update request from the data source is detected by the microprocessor during the normal execution, the firmware update subroutine of the booting program will be performed to switch the next procedure to the step S400.

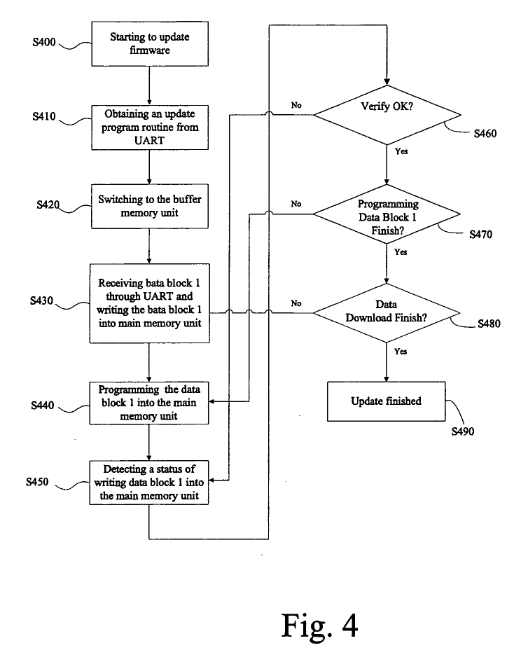

A flow chart of a data control method for a firmware update of the global navigation satellite system is further shown as in FIG. 4, including the following steps.

In step S400, the firmware update procedure of the global navigation satellite system starts after the booting procedure shown in FIG. 3 is finished.

In step S410, the microprocessor will move an updating-firmware program routine (as a download agent, DA) from the data source to the buffer memory unit via the UART serial interface employing a data transfer rate. If the serial interface is being used, the microprocessor still can handshake with the data source successfully for obtaining the update program routine.

In step S420, after the update program routine is moved into the buffer memory unit, a pointer counter of the microprocessor will be pointed to an area of the buffer memory unit where the update program routine is addressed, thereby executing the update program routine to control the oncoming updating firmware procedure.

In Step S430, the microprocessor will sequentially transfer each data block (e.g. a data block 1) of an updated firmware codes from the data source to the buffer memory unit via the UART serial interface, and then sequentially write the data block from the buffer memory unit into the main memory unit at a data accessing rate faster than the data transfer rate of the UART serial interface. Before writing the data block to the main memory unit, the microprocessor can identify either a size-unchanged data block or a decompressed data block ready to be stored into the main memory unit. If the data block transferred from the data source via the serial interface has been pre-compressed in its bit size, a decompressor can be enabled by the microprocessor to decompress the data block prior to entry of the data block into the main memory unit. In another case, the data blocks can be firstly decompressed before the data blocks are fetched by the microprocessor from the buffer memory to be stored within the main memory unit.

In Step S440, the microprocessor will serially program each data block (e.g. the data block 1) of the updated firmware codes into the main memory unit for replacing a previous executable firmware codes existing in the main memory unit.

In Step S450, a status signal of writing the data block into the main memory unit, which is generated from the main memory unit, will be detected by the microprocessor. Basically, there are two ways to verify whether each data block is successfully written into the main memory unit or not. One way is to read out a data address relative to the written data block from the main memory unit thereby verifying if the data writing of the step S440 is successful. The other way is to pull a specific toggle bit from the main memory unit, with regard to the written data block. Since the specified toggle bit can notify the microprocessor in response to the status of programming data block as the step S440.

In step S460, if the status signal generated from the main memory unit cannot responses a successful result. The procedure will return to the step S450 for detecting the status signal again. Otherwise, if the status signal indicates a successful result, the procedure will go to a step S470.

In step S470, it is determined whether the data block 1 is programmed successfully or not. If so, the procedure will go to a step S480, and otherwise returns to the step S440 for programming the data block 1 into the main memory unit again.

In step S480, it is further determined whether all of the data blocks of the updated firmware codes are downloaded into the main memory unit successfully or not. If so, the procedure will go to a step S490 for ending this firmware update to reboot configuration of the GNSS as shown in FIG. 3, and otherwise returns to the step S430 for contiguously receiving the next data block from the UART serial interface to be stored within the main memory unit until all of the data blocks of the updated firmware codes are downloaded completely. While a data block download (i.e. a flash download) into the main memory unit is failed or not, the accomplishment of the firmware update can be guaranteed finally by way of contiguous verification and re-download for the failure. For the other requirements, the microprocessor can program some signatures into the main memory unit to determine the success of the data block download or not. Please note that if the main memory unit is empty, all of the data blocks download will be done for a first time.

Understandably, the size reduction of an integrated chip and convenience of a data block download are very important for a global navigation satellite system. Therefore the present invention utilizes a UART serial interface with usage of less I/O pins to save more area costs. Moreover, the present invention utilizes pre-compression of the data blocks to reduce the data transfer time from the data source to the main memory unit through the serial interface, thereby eliminating a speed bottleneck of the data transfer rate which is slower than the data accessing rate of the main memory unit. Thus, the data download efficiency can be greatly raised.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A data control apparatus applied for a global navigation satellite system, comprising:
a serial transport interface employing a data transfer rate to transmit a number of specific data between the global navigation satellite system and a data source, the specific data containing at least one program routine and data blocks in a compressed bit size;
a main memory unit accessing the data block at a data accessing rate faster than the data transfer rate of the serial transport interface; and
a microprocessor coupled to the main memory unit and the serial transport interface, performing the program routine to sequentially write at least one part of the specific data into the main memory unit.

2. The system as claimed in claim 1, further comprising a buffer memory unit coupled to the microprocessor for pre-storing the specific data therein through the microprocessor.

3. The system as claimed in claim 1 wherein the serial transport interface is a universal asynchronous receiver transmitter (UART).

4. The system as claimed in claim 1, wherein the data blocks are updated firmware codes, and the program routine is a download agent program for instructing the microprocessor to download the updated firmware codes from the data source to the main memory unit.

5. The system as claimed in claim 1, further comprising a decompressor for decompressing the bit size of the compressed data blocks.

6. The system as claimed in claim 5, wherein the decompressor interconnects between the microprocessor and the main memory unit and decompresses the data blocks before the data blocks are written into the main memory unit.

7. The system as claimed in claim 5, further comprising a buffer memory unit coupled to the microprocessor for pre-storing the data therein through the microprocessor, wherein the decompressor interconnects between the microprocessor and the buffer memory unit and decompresses the data blocks before the data blocks are fetched by the microprocessor from the buffer memory unit.

8. The system as claimed in claim 5, wherein the microprocessor depends upon occurrence of compression character in the data block transmitted from the data source to enable the decompressor to decompress the data block.

9. The system as claimed in claim 8 further comprising a selector is controlled by the microprocessor to determine whether to output either the size-unchanged data block or the decompressed data block to the main memory unit.

10. The system as claimed in claim 9, wherein the selector is a multiplex.

11. The system as claimed in claim 1 wherein the main memory unit is a flash memory, which stores some executable firmware codes for controlling the global navigation satellite system.

12. A method for updating executable codes in a global navigation satellite system having a microprocessor, a serial transport interface and a main memory unit, comprising the steps of:
fetching a program routine from a data source through the transport interface employing a data transfer rate;
executing the program routine;
sequentially transferring a number of data blocks compressed in a bit size from the data source via the serial transport interface; and
writing each data block into the main memory unit at a data accessing rate faster than the data transfer rate of the serial transport interface.

13. The method as claimed in claim 12 wherein the data blocks are updated executable codes, and the program routine is a download agent program for instructing the microprocessor to download the updated executable codes from the data source to the main memory unit.

14. The method as claimed in claim 13, further comprising:
programming each of the data blocks into the main memory unit; and
verifying whether the data block is successfully written into the main memory unit.

15. The method as claimed in claim 13 further comprising a step of decompressing the data blocks before or after storing the data blocks within a buffer memory unit.

16. The method as claimed in claim 12, wherein the serial transport interface is a universal asynchronous receiver transmitter (UART).

17. The method as claimed in claim 12, further comprising a step of decompressing the data blocks before the data blocks are written in the main memory unit.

18. The method as claimed in claim 12, further comprising a step of decompressing the data block depending upon occurrence of compression character in each data block transmitted from the data source.

19. The method as claimed in claim 18, further comprising a step of identifying either a size-unchanged data block or a decompressed data block supplied to the main memory unit.

20. The method as claimed in claim 12, wherein the main memory unit is a flash memory, which stores the executable codes for controlling the global navigation satellite system.
